(19) United States
(12) Patent Application Publication
(10) Pub. No.: US 2017/0218157 A1
(43) Pub. Date: Aug. 3, 2017

(54) POLYURETHANE FOAM WITH REDUCED FORMALDEHYDE AND ACROLEIN EMISSIONS

(71) Applicants: HYUNDAI MOTOR COMPANY, Seoul (KR); KIA MOTORS CORPORATION, Seoul (KR)

(72) Inventors: Sung-Hoon LEE, Seoul (KR); Byung-Guk LIM, Seoul (KR); Kwon-Yong CHOI, Seoul (KR); Hyun-Jong LEE, Ulsan (KR); Soon-Joon JUNG, Seoul (KR); Tae-Hwan SON, Ulsan (KR); Young-Hoon HAN, Ulsan (KR)

(21) Appl. No.: 15/204,750

(22) Filed: Jul. 7, 2016

(30) Foreign Application Priority Data
Jan. 29, 2016 (KR) 10-2016-0011508

(51) Int. Cl. C08J 9/00; C08G 18/08

(52) U.S. Cl. CPC C08J 9/0066; C08G 18/14; C08J 2375/04

(57) ABSTRACT

A polyurethane foam with reduced formaldehyde and acrolein emissions, which is manufactured from a polyol system including polyol, a foam stabilizer, a foaming agent, and a liquid aldehyde reducing agent.

### CROSS-REFERENCE TO RELATED APPLICATIONS

This application claims the benefit of priority under 35 U.S.C. §119 to Korean Patent Application No. 10-2016-0011508, filed on Jan. 29, 2016 with the Korean Intellectual Property Office, the disclosure of which is incorporated herein by reference in its entirety.

### TECHNICAL FIELD

The present disclosure relates to a polyurethane foam with reduced formaldehyde and acrolein emissions, and a polyurethane foam which reduces the emission of toxic components by adding a liquid aldehyde reducing agent to a polyol system.

### BACKGROUND

Seats used in automobile interiors are parts mounted inside an automobile such that drivers may drive their cars comfortably while being seated. Polyurethane foam materials are frequently used for the seats due to excellent cushion properties and lightweight properties, mass productivity, economic efficiency, and the like. In general, polyurethane foam is prepared by a high temperature synthesis process of a polyol system including polyol, a foaming agent, a catalytic agent, a foam stabilizer, water, and the like with isocyanate. However, when the polyurethane foam is prepared, the process may emit volatile organic compounds (VOCs) such as benzene, toluene, and formaldehyde for a short period of time and/or for a long period of time.

The VOCs generate odors as carcinogenic materials of hydrocarbon compounds and may be responsible for causing nervous system disorders and sick house syndromes due to their inhalation. Recently, as the number of vehicles used has increased, interest in eco-friendly materials throughout the automobile industry and the air quality of vehicle interiors has been increasing. In Korea, the Ministry of Land, Infrastructure, and Transport issued management standards capable of protecting the health of vehicle drivers by appropriately managing materials toxic to the human body, which are emitted from interior parts of newly manufactured vehicles since 2007, and currently, the motor vehicle management act was established as Act No. 11929, which only allows seven VOCs emitted from newly manufactured vehicles at the regulation values or less.

Therefore, the present disclosure relates to a polyurethane foam with reduced formaldehyde and acrolein emissions, and more particularly, to a soft polyurethane foam for seats, including a liquid aldehyde reducing agent which suppresses the generation of volatile organic compounds emitted from a soft polyurethane foam for vehicle seats.

### SUMMARY

The present disclosure has been made in an effort to provide a polyurethane foam with reduced formaldehyde and acrolein emissions, including a liquid aldehyde reducing agent which suppresses the generation of volatile organic compounds emitted from a soft polyurethane foam for vehicle seats.

Further, the present disclosure has been made in an effort to provide a seat for a vehicle, which suppresses the generation of volatile organic compounds.

The technical problems which the present disclosure intends to solve are not limited to the technical problems which have been mentioned above, and still other technical problems which have not been mentioned will be apparently understood by those skilled in the art from the description of the present disclosure.

An exemplary embodiment of the present disclosure provides a polyurethane foam with reduced formaldehyde and acrolein emissions, which may be manufactured of, or from, a polyol system comprising polyol, a foam stabilizer, a foaming agent, and a liquid aldehyde reducing agent.

In the present disclosure, the polyol may be prepared in an alkali form.

In the present disclosure, the polyol, the catalytic agent, the foam stabilizer, and the foaming agent may be present in amounts of 90 to 95 wt %, 0.1 to 1.4 wt %, 0.1 to 1.6 wt %, and 1.0 to 7.0 wt %, respectively, based on a total weight of the polyol system prior to a foaming of the polyurethane foam.

In the present disclosure, the liquid aldehyde reducing agent may be present in an amount of 0.4 to 2.0 wt %.

In the present disclosure, the liquid aldehyde reducing agent may include a compound having an amine group, a natural compound having an antioxidant function, a surfactant and a solvent having a hydroxyl group.

In the present disclosure, the compound having an amine group may include a compound composed of hydroxyl amine.

In the present disclosure, the compound having an amine group may include one or more of hydroxylamine, hydroxylamine sulfate, N-methylethanolamine, ethanolamine and tris(hydroxymethyl)aminomethane.

Another exemplary embodiment of the present disclosure provides a seat for a vehicle, which is manufactured of polyurethane.

The polyurethane foam with reduced formaldehyde and acrolein emissions according to the present disclosure may have an effect of providing a polyurethane foam with reduced formaldehyde and acrolein emissions, including a liquid aldehyde reducing agent which suppresses the generation of volatile organic compounds emitted from a soft polyurethane foam for vehicle seats.

The seat for a vehicle according to the present disclosure may have an effect of providing a seat for a vehicle, which suppresses the generation of volatile organic compounds.

### DETAILED DESCRIPTION

Hereinafter, exemplary embodiments of the present disclosure will be described in detail with reference to the accompanying drawings. Prior to the description, the terms or words used in the present specification and the claims should not be interpreted as being limited to typical or dictionary meanings, and should be construed as meanings and concepts conforming to the technical spirit of the present disclosure on the basis of the principle that an inventor can appropriately define concepts of the terms in order to describe his or her own disclosure in the best way. Accordingly, since the exemplary embodiments described in the present specification and the configurations illustrated in the drawings are only possible embodiments of the present disclosure and do not represent all of the technical spirit of the present disclosure, it is to be understood that various equivalents and modified embodiments, which may replace these exemplary embodiments and configurations, are possible.

As global environmental contamination issues have recently emerged as serious problems, the automobile industry has made various efforts to apply eco-friendly materials to vehicles. In particular, as the time for staying in vehicles is prolonged due to an increase in use of vehicles, interest in the air quality in a vehicle interior has increased.

To solve such problems, measures to develop air cleaners applied to vehicles or to develop indoor parts for vehicles using eco-friendly materials have been suggested. In particular, polyurethane foam, which occupies the largest volume among materials applied to interiors of vehicles, has price competitiveness as well as excellent functionality such as sound absorption and sound insulation, and thus has been widely used for automobile interior parts, such as seats, dashboards, and floor material. However, when polyurethane foam is prepared, there is a disadvantage in that formaldehyde and acrolein, which are toxic to the human body by thermal reactions, are emitted in large amounts.

In order to reduce VOCs, in the related art, adsorbents on which organic compounds such as amines, hydrazines, and ureas or metal salts and the like which are reactive with lower aldehydes are supported have been used in a porous support, but since the adsorbents are powder-types, it is difficult to mix the adsorbent in polyol, and thus there is a problem in that polyol is unstable in itself or the adsorption rate of aldehyde is slow.

The present disclosure relates to a polyurethane foam which reduces emission of formaldehyde and acrolein by adding a liquid aldehyde reducing agent to a polyol system.

In general, the polyurethane foam may refer to a polymer material having porous bubbles in which the molecular structure is composed of urethane. For the preparation of polyurethane foam, the polyurethane foam may be produced by reacting a polyol system with isocyanate, and may be classified into hard and soft urethane foam according to the kinds and characteristics of the polyol system and the isocyanate used. Urethane foam for automobile seats may be classified as soft urethane foam, and serves to contribute to the sense of comfort when passengers are seated.

As regulations on the vehicle interior air quality have been tightened, technologies for reducing the amount of VOCs emitted with respect to automobile interior parts have been developed. Among them, the urethane foam for seats is an automobile interior part having the largest volume among automobile interior parts, and thus a technology for reducing VOCs may be beneficial. The VOCs may be classified into BTXs such as benzene, toluene, and xylene and aldehydes such as formaldehyde, acetaldehyde, and acrolein, and among them, aldehydes are known to be materials which cause diseases such as sick home syndrome to the human body. Therefore, the present disclosure relates to the preparation of polyurethane foam for automobile seats, which may reduce formaldehyde and acrolein emissions.

Aldehydes are produced from the polyurethane foam as an active hydroxyl group (—OH) of polyol is oxidized. Since a large amount of hydroxyl groups may be present in the polyurethane foam, the hydroxyl groups may be oxidized, and as a result, a large amount of aldehydes may be constantly emitted. The present disclosure provides a polyurethane foam for seats prepared under the optimal blending conditions of a polyurethane foam by adding an amine-based liquid aldehyde reducing agent to a polyol system including polyol, a crosslinking agent, a catalytic agent, a foam stabilizer, a foaming agent, and the like in order to reduce formaldehyde and acrolein. That is, in order to enhance the efficiency of reducing specific formaldehyde and acrolein generated from soft polyurethane foam for seats in the related art, the amine-based liquid aldehyde reducing agent may have an object to provide a soft urethane foam for seats, in which toxic components are blocked by adding a suitable liquid aldehyde reducing agent to the soft polyurethane foam for seats.

According to the present disclosure, there may be provided a polyurethane foam with reduced formaldehyde and acrolein emissions, which may be manufactured of a polyol system including polyol, a foam stabilizer, a foaming agent, and a liquid aldehyde reducing agent. The polyol may be prepared in an alkali form, and the polyol, the catalytic agent, the foam stabilizer, and the foaming agent may be present in an amount of 90 to 95 wt %, 0.1 to 1.4 wt %, 0.1 to 1.6 wt %, and 1.0 to 7.0 wt %, respectively based on a total weight of the polyol system prior to foaming of the polyurethane foam. In addition, the liquid aldehyde reducing agent may be present in an amount of 0.4 to 2.0 wt %, and may include a compound having an amine group, a natural compound having an antioxidant function, a surfactant, and a solvent having a hydroxyl group. Furthermore, the compound having an amine group may include a component composed of hydroxyl amine. Moreover, the compound having an amine group may include one or more of hydroxylamine, hydroxylamine sulfate, N-methylethanolamine, ethanolamine, and tris(hydroxymethyl)aminomethane.

The liquid aldehyde reducing agent of the present disclosure may reduce formaldehyde and acrolein in the polyurethane foam through the mechanisms such as the following Chemical Formulae 1 to 5.

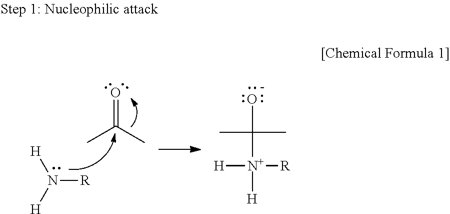

Chemical Formula 1 may indicate step 1 in the reaction mechanism of an amine-based liquid aldehyde reducing agent which may reduce formaldehyde and acrolein with formaldehyde and acrolein. Due to a partial positive charge of carbonyl carbon, the unshared electron pair of the amine-based liquid aldehyde reducing agent nucleophilically may attack formaldehyde and acrolein to form a bipolar regular tetrahedron intermediate.

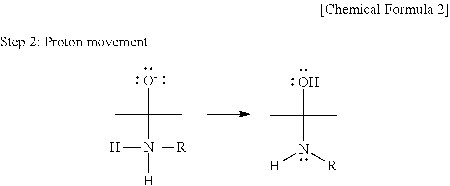

Chemical Formula 2 may indicate step 2 in the reaction mechanism of an amine-based liquid aldehyde reducing agent which may reduce formaldehyde and acrolein with formaldehyde and acrolein. With respect to the proton movement, protons may move from nitrogen to oxygen to form a neutral carbinolamine.

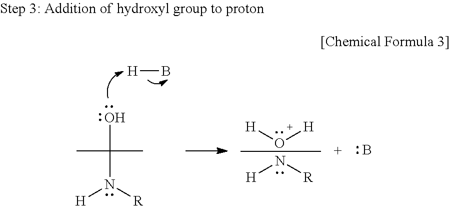

Chemical Formula 3 may indicate step 3 in the reaction mechanism of an amine-based liquid aldehyde reducing agent which may reduce formaldehyde and acrolein with formaldehyde and acrolein. The protonation reaction of the hydroxyl group (—OH) may be carried out by an acid-catalyst.

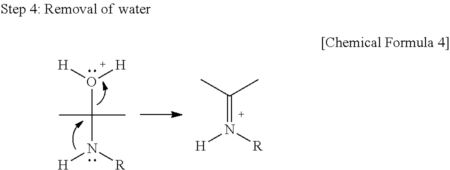

Chemical Formula 4 may indicate step 4 in the reaction mechanism of an amine-based liquid aldehyde reducing agent which may reduce formaldehyde and acrolein with formaldehyde and acrolein. The unshared electron pair may discharge water and form an iminium ion.

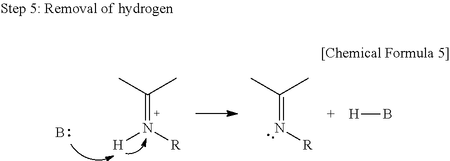

Chemical Formula 5 may indicate step 5 in the reaction mechanism of an amine-based liquid aldehyde reducing agent which may reduce formaldehyde and acrolein with formaldehyde and acrolein. A proton may be lost from nitrogen and a neutral imine product may be formed.

Through the reaction mechanism as described above, the formaldehyde and acrolein in the polyurethane foam may be changed into imine by an amine-based liquid aldehyde reducing agent, so that a considerable amount of formaldehyde and acrolein emissions may be reduced. Furthermore, since the liquid aldehyde reducing agent may take a chemically stable form in the polyurethane foam, the present disclosure may exhibit the effect over a long period of time compared to the related art. Further, when formaldehyde and acrolein in the polyurethane foam of the present disclosure are emitted, the liquid aldehyde reducing agent may rapidly undergo a chemical reaction with formaldehyde and acrolein due to high reactivity with the liquid aldehyde reducing agent, and there may be an effect of minimizing the amount of formaldehyde and acrolein emitted to the outside of the polyurethane foam by changing formaldehyde and acrolein into imine. Furthermore, the liquid aldehyde reducing agent may be a liquid type, and may have an effect which is excellent in keeping the raw material compared to the related art because a mixture is easily prepared in a polyol system according to the required amount, and no precipitate is produced. Further, there may be an advantage in that the present disclosure may be composed of an amine group compound without using an expensive photocatalyst or a metal salt support in the related art, and thus the preparation costs may be lower than those in the related art. Additionally, there may be an advantage in that formaldehyde and acrolein compounds may be basically removed due to the reduction reaction of the liquid aldehyde reducing agent.

When more specifically reviewed, the present disclosure may include polyol, a catalytic agent, a foam stabilizer, a foaming agent, and a liquid aldehyde reducing agent in an amount of 90 to 95 wt %, 0.1 to 1.4 wt %, 0.1 to 1.6 wt %, 1.0 to 7.0 wt %, and 0.4 to 2.0 wt %, respectively based on the total weight of the polyol system prior to foaming of the polyurethane foam.

The liquid aldehyde reducing agent may include a compound having an amine group, a natural compound having an antioxidant function, a surfactant, and a solvent having a hydroxyl group, and may contain a component including hydroxylamine in the compound having an amine group in order to maximize the efficiency of reducing toxic components such as formaldehyde and acrolein generated from soft polyurethane foam for seats. The polyol used as a raw material for soft polyurethane foam for automobile seats may be generally prepared in the alkali form by adding various catalysts in order to have rapid reactivity with isocyanate. The hydroxylamine may have better reactivity than other components having an amine group under the alkali conditions and may combine with formaldehyde and acrolein to be converted into oxime, and thus may maximize the efficiency of reducing formaldehyde and acrolein when polyurethane is synthesized. A reaction in which the hydroxylamine is reacted with formaldehyde and acrolein to produce oxime may be in the same manner as in the following Chemical Formula 6.

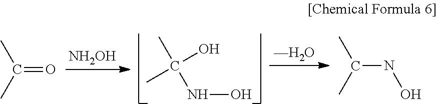

The compound having hydroxylamine may include one or more of hydroxylamine, hydroxylamine sulfate, N-methylethanolamine, ethanolamine, and tris(hydroxymethyl)aminomethane.

In the present disclosure, in order to confirm the effects when the liquid aldehyde reducing agent was added and according to the weight of the liquid aldehyde reducing agent, a test for evaluating formaldehyde and acrolein emissions was conducted by preparing urethane foam in each content of the liquid aldehyde reducing agent, that is, 0.4 wt %, 0.8 wt %, 1.2 wt %, 1.6 wt %, and 2.0 wt % in a predetermined polyol system.

The test method is as follows. In the first step, a sample was manufactured by cutting the foamed polyurethane foam according to the present disclosure into a size of 10×10×2 cm. In the second step, the cut samples were put into a 3 L odor bag and 3 L of nitrogen were introduced into the odor bag. In the third step, the odor bag was put into a dry oven set to 65° C. after the introduction of nitrogen, and heated for 2 hours. In the fourth step, adsorption and extraction were performed in a DNPH cartridge after the heating for 2 hours, and in the fifth step, the adsorbed and extracted cartridge was subjected to instrumental analysis by using HPLC.

TABLE 1

| | Amount of liquid aldehyde reducing agent added | | | | | |
|---|---|---|---|---|---|---|
| | 0 wt % | 0.4 wt % | 0.8 wt % | 1.2 wt % | 1.6 wt % | 2.0 wt % |
| Amount of | 176 | 83 | 45 | 38 | 23 | 21 |
| formaldehyde | | | | | | |
| detected | | | | | | |
| (μg/m³) | | | | | | |
| Amount of | 113 | 63 | 24 | 18 | 15 | 11 |
| acrolein | | | | | | |
| detected | | | | | | |
| (μg/m³) | | | | | | |
| Reducing | | 49% | 76% | 81% | 87% | 89% |
| efficiency | | | | | | |

Table 1 shows the test results conducted by the test method as described above. When the liquid aldehyde reducing agent is not added in the present disclosure, the amount of formaldehyde detected is 176 μg/m³ and the amount of acrolein detected is 113 μg/m³. In contrast, when the liquid aldehyde reducing agent is added in an amount of 0.4 wt % thereto, the amount of formaldehyde detected is 83 μg/m³ and the amount of acrolein detected is 63 μg/m³, and it is possible to confirm the reduction efficiency by 49% compared to the case where the liquid aldehyde reducing agent is not added. In addition, when the liquid aldehyde reducing agent is added in an amount of 0.8 wt % thereto, the amount of formaldehyde detected is 45 μg/m³ and the amount of acrolein detected is 24 μg/m³, and it is possible to confirm the reduction efficiency by 76% compared to the case where the liquid aldehyde reducing agent is not added, and when the liquid aldehyde reducing agent is added in an amount of 1.2 wt % thereto, the amount of formaldehyde detected is 38 μg/m³ and the amount of acrolein detected is 18 μg/m³, and it is possible to confirm the reduction efficiency by 81% compared to the case where the liquid aldehyde reducing agent is not added. Furthermore, when the liquid aldehyde reducing agent is added in an amount of 1.6 wt % thereto, the amount of formaldehyde detected is 23 μg/m³ and the amount of acrolein detected is 15 μg/m³, and it is possible to confirm the reduction efficiency by 87% compared to the case where the liquid aldehyde reducing agent is not added, and when the liquid aldehyde reducing agent is added in an amount of 2.0 wt % thereto, the amount of formaldehyde detected is 21 μg/m³ and the amount of acrolein detected is 11 μg/m³, and it is possible to confirm the reduction efficiency by 89% compared to the case where the liquid aldehyde reducing agent is not added. Through an analysis of the present test result, it can be confirmed that when the liquid aldehyde reducing agent is added in an amount of 0.8 wt % thereto, the highest efficiency of reducing formaldehyde and acrolein is obtained compared to the content of the liquid aldehyde reducing agent.

In the present disclosure, the ratio of the liquid aldehyde reducing agent added may be an important blending element for reducing VOCs. In the present disclosure, the content of the liquid aldehyde reducing agent may be 0.4 to 2.0 wt %. If the liquid aldehyde reducing agent is present in an amount of more than 2.0 wt %, the costs may be increased and the amine catalyst contained in polyol may be affected, so that the moldability and physical properties may be adversely affected when the polyurethane foam with reduced formaldehyde and acrolein emissions according to the present disclosure is prepared. Meanwhile, when the liquid aldehyde reducing agent is present in an amount of less than 0.4 wt %, the efficiency of reducing formaldehyde and acrolein may rapidly deteriorate, so that there is a problem in that the amount of formaldehyde and acrolein emitted may be increased.

Meanwhile, another aspect of the present disclosure may provide a seat for a vehicle, which is manufactured of polyurethane. When a seat for a vehicle is prepared by using the polyurethane foam of the present disclosure, there is an effect of providing a seat for a vehicle, which suppresses the generation of volatile organic compounds.

### EXAMPLES

Hereinafter, the present disclosure will be described in more detail through the following Examples. These Examples are only for exemplifying the present disclosure, and it will be obvious to those skilled in the art that the scope of the present disclosure is not interpreted to be limited by these Examples.

In the case of manufacturing a seat for a vehicle by using polyurethane foam to which 0.8 wt % of the liquid aldehyde reducing agent may be added according to the Example of the present disclosure and the case of manufacturing a seat for a vehicle by using polyurethane foam to which the liquid aldehyde reducing agent may not be added according to the Comparative Example in the related art, the amounts of formaldehyde and acrolein emitted from the seat for a vehicle were analyzed. The following Table 2 shows data which analyze the present disclosure and the related art.

TABLE 2

| | Comparative | | |
|---|---|---|---|
| Item | Example | Example | Remark |
| Formaldehyde | 482 to 494 | 76 to 80 | Reduced by |
| | μg/m³ | μg/m³ | 84% |
| Acrolein | 119 to 133 | 64 to 66 | Reduced by |
| | μg/m³ | μg/m³ | 49% |

As shown in Table 2, the amount of formaldehyde emitted in the Comparative Example which is the related art was 482 to 494 μg/m³. However, in the Example of the present disclosure, it could be confirmed that the amount of formaldehyde emitted was 76 to 80 μg/m³, which was reduced by 84% compared to the Comparative Example. Furthermore, the amount of acrolein emitted in the Comparative Example which is the related art was 119 to 133 μg/m³. However, in the Example of the present disclosure, could be confirmed that the amount of formaldehyde emitted was 64 to 66 μg/m³, which was reduced by 84% compared to the Comparative Example.

The present disclosure has advantages in that by including a liquid aldehyde reducing agent in a polyol system used for preparing polyurethane foam, the preparation costs become relatively inexpensive and the liquid aldehyde reducing agent may take a stable form in the polyurethane foam, and thus the durability may be excellent and the reaction rate of formaldehyde and acrolein with the liquid aldehyde reducing agent may be so rapid that formaldehyde and acrolein may be rapidly removed, and the liquid aldehyde reducing agent may be in a liquid form, and thus easily prepared. Furthermore, when a seat for a vehicle is prepared by using the polyurethane foam with reduced formaldehyde and acrolein emissions according to the present disclosure, there may be an advantage in that it is possible to reduce the occurrence of the diseases of the users of vehicles by reducing formaldehyde and acrolein emissions.

As described above, the present disclosure has been described in relation to exemplary embodiments of the present disclosure, but the exemplary embodiments are only illustrative and the present disclosure is not limited thereto. The exemplary embodiments described may be changed or modified by those skilled in the art to which the present disclosure pertains without departing from the scope of the present disclosure, and various alterations and modifications are possible within the technical spirit of the present disclosure and the equivalent scope of the claims which will be described below.

What is claimed is:

1. A polyurethane foam with reduced formaldehyde and acrolein emissions, which is manufactured from a polyol system comprising:
polyol;
a foam stabilizer;
a foaming agent; and
a liquid aldehyde reducing agent.

2. The polyurethane foam of claim 1, wherein the polyol is prepared in an alkali form.

3. The polyurethane foam of claim 1, wherein the polyol, the catalytic agent, the foam stabilizer, and the foaming agent are present in amounts of 90 to 95 wt %, 0.1 to 1.4 wt %, 0.1 to 1.6 wt %, and 1.0 to 7.0 wt %, respectively, based on a total weight of the polyol system prior to a foaming of the polyurethane foam.

4. The polyurethane foam of claim 3, wherein the liquid aldehyde reducing agent is present in an amount of 0.4 to 2.0 wt %.

5. The polyurethane foam of claim 4, wherein the liquid aldehyde reducing agent comprises a compound having an amine group, a natural compound having an antioxidant function, a surfactant and a solvent having a hydroxyl group.

6. The polyurethane foam of claim 5, wherein the compound having an amine group comprises a compound composed of hydroxylamine.

7. The polyurethane foam of claim 5, wherein the compound having an amine group comprises one or more of hydroxylamine, hydroxylamine sulfate, N-methylethanolamine, ethanolamine, and tris(hydroxymethyl)aminomethane.

8. A seat for a vehicle, which is manufactured of the polyurethane foam of claim 7.
